(19) United States
(12) Patent Application Publication
(10) Pub. No.: US 2003/0204452 A1
(43) Pub. Date: Oct. 30, 2003

(54) Method and system for providing automated e-mail item tracking status messages

(76) Inventor: William Wheeler, Sand Springs, OK (US)

Correspondence Address: WALL MARJAMA & BILINSKI, 101 SOUTH SALINA STREET, SUITE 400, SYRACUSE, NY, 13202, US

(21) Appl. No.: 10/238,383

(22) Filed: Sep. 10, 2002

Related U.S. Application Data
(60) Provisional application No. 60/375,699, filed on Apr. 26, 2002.

(51) Int. Cl. G06F 17/60

(52) U.S. Cl. 705/28

(57) ABSTRACT

The present invention is directed to a system and method for tracking an item being shipped from a sender to a recipient. The item traverses a shipping route that includes at least one tracking point facility. The method includes affixing a machine-readable identifier on the item at a first location. The machine-readable identifier encodes data corresponding to the sender's e-mail address, the recipient's e-mail address, and an item description. The machine-readable identifier is read at the at least one tracking point facility. A tracking status e-mail is automatically transmitted in response to the step of reading. The e-mail is transmitted to at least one of the sender and the recipient, or both.

### CROSS-REFERENCE TO RELATED APPLICATIONS

This application claims priority under 35 U.S.C. §119(e) based on U.S. Provisional Patent Application Serial No. 60/375,699, filed Apr. 26, 2002, the contents of which are relied upon and incorporated herein by reference in their entirety.

### BACKGROUND OF THE INVENTION

1. Field of the Invention

The present invention relates generally to tracking packaged items in a distribution system, and particularly to tracking packaged items using e-mail tracking status messages generated by a 2D barcode.

2. Technical Background

The United States Postal Service (USPS) and other shipping companies (FedEx, UPS, and etc.) typically process several millions of packages on a daily basis. In order to increase the accuracy and efficiency of this process, package sorting and routing systems are becoming increasingly automated. For many mailed and shipped items, information relating to the delivery time and transit status of a given parcel is just as important as the item itself. Thus, the ability to track items that are being shipped is becoming increasingly important.

Tracking capability is presently available for selected postal products (e.g., Express Mail) and for most private shipment service companies, such Federal Express, UPS, and etc. In the approach currently being employed, each parcel is assigned an arbitrary tracking number. The tracking number is provided to the sender of the item. The sender may obtain transit status information using the tracking number either by calling the shipper, or by visiting the shipper's website. Typically, the recipient of the item has no knowledge of the tracking number, and may not even know that the item is in transit to the recipient's location. The current tracking system is only used if there is a failure, e.g., a package is lost, mis-routed, and does not arrive when and where it is supposed to. Thus, the present system and methods are reactive in nature.

There are drawbacks to the above described approach. The tracking number system provides the desired information only if proactive steps are taken by the sender to obtain and retain the tracking number. Further, the sender must actively query the shipper's tracking system by calling the shipper or by visiting the shipper's web-site. The only way the recipient can access status information is by obtaining the tracking number from the sender, and taking the same proactive steps described above. Of course, the recipient may not even know the item, or items, are being shipped to him.

In another approach that has been considered, software programs have been developed whereby the sender may be automatically notified of item delivery either electronically (e.g., the USPS Confirm program) or by paper means (e.g., Registered Mail, receipt requested). However, these methods either require an established business and/or system relationship with the service provider, or ponderous paperwork and a willingness to wait an extended period of time for the information.

What is needed is a simple means whereby either the sender or the recipient, or both, might receive automatic updates of an item's transit status without necessarily being aware of the existence of an item tracking number. While a tracking number may be important to the shipping company, it is unimportant and meaningless to the sender and the recipient. The only reason why an arbitrary tracking number would be of importance to a sender or recipient is because of its utility in tracking a given item. What is important to the sender and recipient, is the transit status of the item, and a meaningful description of the item. For example, in a “just-in-time” manufacturing environment, the manufacturer needs to know before hand if a component shipment is going to arrive on time. If the manufacturer is informed ahead of time that the shipment of components is not going to arrive, alternative arrangements can be made to avoid interruptions in the manufacturing process.

### SUMMARY OF THE INVENTION

The present invention provides a system and method whereby either the sender or the recipient, or both, receive automatic updates of item transit status without necessarily being aware of the existence of an item tracking number.

One aspect of the present invention is directed to a method for tracking an item being shipped from a sender to a recipient. The item traverses a shipping route that includes at least one tracking point facility. The method includes affixing a machine-readable identifier on the item. The machine-readable identifier encodes data corresponding to the sender's e-mail address, the recipient's e-mail address, and an item description. The machine-readable identifier is read at the at least one tracking point facility. A tracking status e-mail is automatically transmitted in response to the step of reading. The e-mail is transmitted to at least one of the sender and the recipient, or both.

In another aspect, the present invention is directed to a system for tracking an item being shipped from a sender to a recipient. The system includes a labeling device configured to affix a machine-readable identifier to the item. The identifier is configured to encode data corresponding to an e-mail tracking notice request field, the sender's e-mail address, the recipient's e-mail address, and an item description. A tracking point facility is configured to read the identifier, generate a tracking status e-mail in response to detecting the e-mail tracking notice request field, and transmit the e-mail to at least one of the sender and the recipient.

In another aspect, the present invention includes a computer-readable medium having computer-executable instructions disposed thereon for performing a method for tracking an item being shipped from a sender to a recipient. The item traverses a shipping route that includes at least one tracking point facility. The method includes reading sender shipping information that includes the sender's e-mail address, the recipient's e-mail address, and a description of the item. The sender shipping information is disposed in a identifier. The identifier is affixed to the item. The at least one tracking point facility automatically transmits a tracking status e-mail to one of the sender and recipient, or both, in response to the step of reading.

In another aspect, the present invention includes a computer-readable medium having computer-executable instructions disposed thereon for performing a method for tracking an item being shipped from a sender to a recipient. The item traverses a shipping route that includes at least one tracking point facility. The method includes reading a identifier affixed to the item. The identifier encodes shipping transaction information. The shipping transaction information includes a sender e-mail address field, a recipient e-mail address field, and an item identification field. A tracking status e-mail is generated in response to the step of reading. The tracking status e-mail is transmitted to at least one of the sender and recipient, or both, in accordance with the shipping transaction information encoded in the optical indicia.

In another aspect, the present invention includes a machine-readable medium having stored thereon a data structure. The data structure includes an e-mail tracking notice request field. The e-mail tracking notice request field includes a command causing a reading device to generate a tracking status e-mail in response to a reading device detecting the e-mail tracking notice request field. The data structure also includes: a sender e-mail address field; a recipient e-mail address field; and an item identification field that includes a description of the item being shipped.

In another aspect, the present invention includes a computer readable medium having stored thereon a data structure corresponding to a tracking status e-mail. The tracking status e-mail is automatically generated in response to reading a machine-readable identifier. The machine-readable identifier is disposed on an item being shipped from a sender to a recipient. The data structure includes: a notification field identifying the sender and recipients of the e-mail; a subject matter field of the tracking status e-mail; an item identification field including a description of the item being shipped; and a tracking status field that includes a status of the item being shipped.

In another aspect, the present invention includes a reading apparatus for reading a machine-readable identifier disposed on an item being shipped from a sender to a recipient. The reading apparatus includes a reader assembly configured to acquire data disposed in the machine-readable identifier. A processor is coupled to the reader assembly. The processor is programmed to detect an e-mail tracking notice request embedded in the machine-readable identifier, decode a sender's e-mail address, a recipient's e-mail address, and an item description embedded in the machine-readable identifier. The processor is also programmed to transmit a tracking status e-mail to at least one of the sender and the recipient, or both, in response to detecting the e-mail tracking notice request.

In another aspect, the present invention includes a system for producing a machine-readable identifier for use in tracking an item being shipped from a sender to a recipient. The system includes a user interface configured to input sender shipping information. The sender shipping information includes an e-mail tracking notice request, the sender's e-mail address, the recipient's e-mail address, and an item description. A controller is coupled to the user interface. The controller is configured to embed the sender shipping information in a machine-readable identifier. An affixing device is coupled to the controller. The affixing device is configured to affix the machine-readable indicia to the item.

In another aspect, the present invention is directed to a method for providing information used for tracking an item being shipped from a sender to a recipient in a computer system having a graphical user interface. The graphical user interface includes a display and at least one input device. The method includes providing at least one data entry icon on the display. The information is input into the at least one data entry icon using the input device. The information includes the sender's e-mail address, the recipient's e-mail address, and a description of the item. The information is encoded in response to the step of inputting, whereby the information is encoded in a machine-readable identifier. The machine-readable identifier is affixed to the item.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

FIG. 1 is a diagrammatic depiction of a system for tracking an item in accordance with an embodiment of the present invention;

FIG. 2 is a block diagram of the labeling system depicted in FIG. 1;

FIG. 3 is a flow chart showing a method of the apparatus depicted in FIG. 2;

FIG. 4 is a representation of a graphical user interface provided by the system depicted in FIG. 2;

FIG. 5 is a block diagram of the tracking station optical indicia reader depicted in FIG. 1;

FIG. 6 is a flow chart showing a method of the apparatus depicted in FIG. 5; and

FIG. 7 is an example of an e-mail tracking status notification in accordance with an embodiment of the present invention.

### DETAILED DESCRIPTION

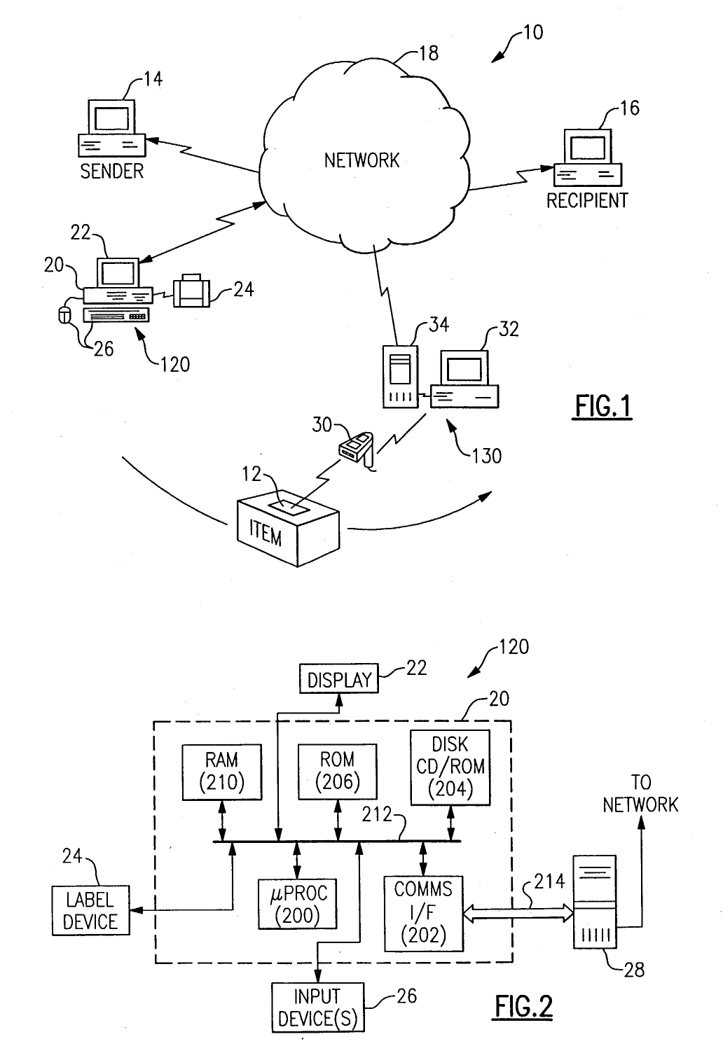

Reference will now be made in detail to the present exemplary embodiments of the invention, examples of which are illustrated in the accompanying drawings. Wherever possible, the same reference numbers will be used throughout the drawings to refer to the same or like parts. An exemplary embodiment of the system of the present invention is shown in FIG. 1, and is designated generally throughout by reference numeral 10.

In accordance with the invention, the present invention is directed to a system for tracking an item being shipped from a sender to a recipient. The system includes a labeling device configured to affix a machine-readable identifier to the item. The machine-readable identifier is configured to encode data corresponding to an e-mail tracking notice request field, the sender's e-mail address, the recipient's e-mail address, and an item description. A tracking point facility is configured to read the machine-readable identifier, generate a tracking status e-mail in response to detecting the e-mail tracking notice request field, and transmit the e-mail to at least one of the sender and the recipient. The present invention provides a simple means whereby either the sender or the recipient, or both, might receive automatic updates of item transit status without necessarily being aware of the item tracking number, or aware of the existence of the fact that the item has been shipped.

As embodied herein, and depicted in FIG. 1, a diagrammatic depiction of a system 10 for tracking an item in accordance with an embodiment of the present invention is disclosed. The term “item” may refer to a single parcel or package, or any variety of freight that is shipped between individuals and/or firms. For example, the item may contain a birthday present being shipped from one individual to another individual. In another context, the item represents freight being shipped from a company or individual to another company or individual.

System 10 includes a labeling system 120 and at least one tracking facility 130 coupled to network 18. The item sender 14, and the recipient 16 of the item, are also coupled to network 18. Labeling system 120 includes computer 20, display 22, input devices 26, and apparatus 24, which is configured to produce machine-readable identifier 12. In one embodiment, machine-readable identifier 12 is a two-dimensional bar code, and apparatus 24 is a bar code printer configured to print a two-dimensional bar code. In another embodiment, machine-readable identifier 12 is an RF tag device. In yet another embodiment, machine-readable identifier 12 is a magnetic card device. Tracking facility 130 includes reader device 30, coupled to computer 32. Computer 32 may be coupled to a shipping agency server 34, or directly coupled to network 18. Those of ordinary skill in the art will recognize that reader 30 may be coupled to computer 32 by either a wire, fiber optic, or wireless connection. In one embodiment, reader 30 is a bar code reader. In other embodiments, reader 30 may be configured to read RF tags or magnetic card devices.

The operation of system 10 is illustrated by the following example. Custody of the item is transferred from sender 14 to an employee of the shipping agency at a shipping/receiving location. In shipping/receiving, labeling system 120 affixes a machine-readable identifier 12 to the item. The item may then be loaded onto a truck and transported to the shipping agency's facilities where various articles of freight are sorted, and combined in Unit Load Devices (ULDs). The ULDs may be loaded onto aircraft and transported to their destination directly, or to one or more intermediate facilities. At the intermediate facilities, some of the freight may be unloaded, while the remainder of the freight is resorted, combined, and loaded onto vehicles such as aircraft, trains, and trucks. In accordance with the present invention, a tracking point facility 130 may be disposed at the shipping/receiving facility, at each intermediate facility, and at the destination facility. Labeling system 120 may also be configured to generate the e-mail as well. Depending on the information stored in the identifier, an e-mail may be generated at a selected one of these tracking points, or at all tracking points. The tracking status e-mail is transmitted by the tracking facility 130 to either the sender 14, the recipient 16, or both.

Network 18 may be embodied as the Internet, a private intra-company network, or a combination of networks. As such, the present invention may be employed to track items in common carrier shipping systems, intra-corporate inventory control systems, “just-in-time” manufacturing environment, or in any other tracking system that places a value on the time-value of information. As those of ordinary skill in the art will appreciate, getting information earlier is valuable and may result in considerable cost savings. For example, in a just-in-time manufacturing environment, a manufacturer can make alternative arrangements if he knows ahead of time that a shipment of components is not going to arrive on time.

Referring to FIG. 2, a block diagram of labeling system 120 in accordance with one embodiment of the present invention is disclosed. In this embodiment, labeling system 120 is a networked system that includes computer 20, which is coupled to display 22, labeling device 24, input devices 26, and server 28. Computer 20 includes microprocessor 200 coupled to communications interface 202, disk/CD-ROM drive 204, ROM 206, and RAM 210 by way of system bus 212.

Server 28 may be of any suitable type, but there is shown by way of example a data server that is employed as repository of all data records generated during the labeling process. In one embodiment, data server 28 may be equipped with Microsoft Windows™ Server software, any suitable off-the-shelf database software, or custom written software.

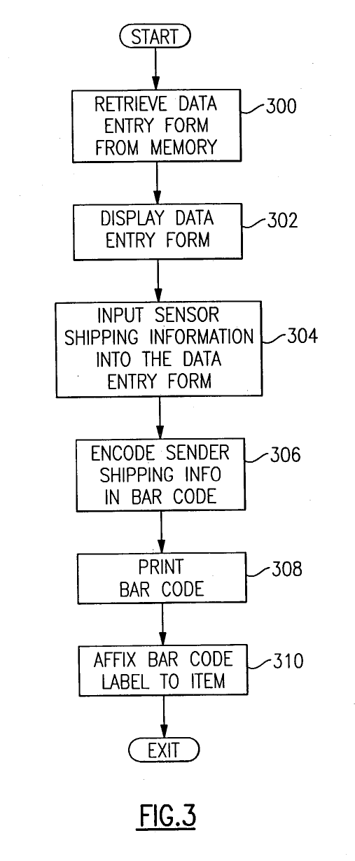

It will be apparent to those of ordinary skill in the pertinent art that processor 200 may be of any suitable type depending on the functionality and sophistication of the firmware resident in ROM 206. In one embodiment, processor 200 is embodied as an Intel Pentium microprocessor. Computer 20 includes a read/write random access memory (RAM) 210 used in data processing and data I/O. Read only memory (ROM) 206 is configured to store computer 20 programming instructions. ROM 206 may be implemented using a DRAM, ROM, PROM, EEPROM, or any other computer readable medium. Disk/CD-ROM drive 204 may accommodate a hard drive, a floppy diskette drive, and/or a CD-ROM drive. In one embodiment, computer 20 may be equipped TM with Microsoft Windows™ software, off-the-shelf application software, and custom-written software configured to execute the method depicted in FIG. 3, which will be discussed in more detail below.

Transmission media include coaxial cables, copper wire and fiber optics, including the wires that comprise bus 212 and interface 214. Transmission media can also take the form of acoustic, optical, or electromagnetic waves, such as those generated during radio frequency (RF) and infrared (IR) data communications.

It will be apparent to those of ordinary skill in the pertinent art that modifications and variations can be made to labeling device 24 of the present invention depending on the technology used to implement the machine-readable identifier. In one embodiment, labeling device 24 is implemented as a two-dimensional bar code printer. Those of ordinary skill in the art will understand that any suitable two-dimensional bar code (Code One, PDF 417, Data Matrix, and etc.) can be used in conjunction with the present invention. For example, Code One bar codes have a character set that consists of all 128 ASCII characters, all 128 Extended ASCIII characters, 1 pad/message separator character and accommodate 8-bit binary data. The maximum data capacity is 2218 text characters (per symbol), 3550 digits, and 1478 bytes. PDF 417 codes have a character set that consists of all 128 ASCII Characters, all Extended ASCII Characters, and 8-Bit Binary Data. PDF 417 also provides error correction capabilities. The maximum data capacity of a PDF 417 symbol (at error correction level 0) is 1850 text characters, 2710 digits, and 1108 bytes. The present invention should not be construed as being limited to the examples depicted above, as any suitable bar code may be employed in implementing the present invention.

In another embodiment, the machine-readable identifier is an RF tag, and labeling device 24 programs the RF tags. In one embodiment, the RF tag includes a passive resonant radio frequency (RF) circuit that is used to detect an interrogation signal when the tag is within a zone monitored by a reader or interrogator, as is well-known in the art. One well-known type of RF circuit includes a coil antenna and a capacitor which together form a resonant circuit with a predetermined resonant frequency. Power for the RF tag is derived from the antenna. The RF tag also includes a programmable integrated circuit (IC) that is connected to the RF circuit. The IC includes a programmable memory for storing the shipping data. Those of ordinary skill in the art will recognize that other tag designs could also be used with the present invention. The invention is not limited to the particular tag described above. For instance, the capacitor could be located on the IC, with only an inductor coil being disposed outside of the IC. The IC outputs a data stream comprised of the stored data when sufficient power is applied thereto. In one embodiment of the invention, the data stream creates a series of data pulses by switching an extra capacitor across the coil antenna for the duration of the data pulses. This changes the resonant frequency of the RF circuit, detuning it from the operational frequency. Thus, instead of the RF circuit returning a simple response signal, it returns a signal containing a packet of preprogrammed information. The packet of information (data pulses) is received and processed by interrogator receiving circuitry and is decoded to provide the shipping identification information related to the item.

In another embodiment, the machine-readable identifier is an magnetic card, and labeling device 24 programs the magnetic card. Because these devices are so well known in the art, a description is omitted for the sake of brevity.

As embodied herein, and depicted in FIG. 3, labeling system 120 operates as follows. To begin the process of affixing machine-readable identifier 12 to the item, microprocessor 200 retrieves at least one data entry template from memory and displays them on display 22, providing the user with a graphical user interface for data entry. The graphical user interface will be described in more detail below. The term memory may refer to ROM 206, or other computer-readable media. In step 304, the user inputs sender shipping information. The user may be a shipping agency employee, or the item's sender. The transaction is recorded in a data record that is stored in data server 28. This information may be used for billing purposes, for example. Steps 306-310 are described with the bar code embodiment in mind. Those of ordinary skill in the art will recognize that the other embodiments described above (RF tag, magnetic card), are equally applicable. Referring to step 306, microprocessor 200 encodes the shipping information in a two-dimensional bar code. The bar code data is transmitted to label printer 24, and the bar code is printed and affixed to the item. At this point, the bar code may be read by a scanning device (not shown) to thereby generate an e-mail. The tracking notice would indicate that the item has been processed by the shipping agency's shipping/receiving department.

Those of ordinary skill in the art will understand that the present invention illustrated herein is readily implemented as a computer-readable medium having computer-executable instructions embodied thereon. The computer-readable medium is capable of being loaded and executed on appropriate computer processing device(s) in order to carry out the method or process steps described. The term “computer-readable medium” as used herein refers to any medium that participates in providing instructions to the processors described herein for execution. Such a medium may take many forms, including, but not limited to, non-volatile media, volatile media, and transmission media. Non-volatile media include dynamic memory, such as RAM 210. Common forms of computer-readable media include, for example, a floppy disk, a flexible disk, hard disk, magnetic tape, any other magnetic medium, a CD-ROM, CDRW, DVD, any other optical medium such as punch cards, paper tape, optical mark sheets, or physical media with patterns of holes or other optically recognizable indicia. Computer-readable media also obviously includes RAM, PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer by way of the network. In such a scenario, the remote computer sends the instructions over a telephone line using a modem. The instructions are loaded into main memory via server 28. Bus 212 conveys the data to main memory, from which a processor retrieves and executes the instructions. The instructions received by main memory may optionally be stored in RAM 210, or on storage device 204 either before or after execution by processor.

Those of ordinary skill in the art will also understand that the present invention illustrated herein is readily implemented as a computer-readable medium having data structures embodied thereon. The shipping information collected during the method described in FIG. 3 may be stored as a record in data server 28. In one embodiment, each shipping record is stored in a data set. A dataset is a named compilation of related shipping records stored on data server 28. The shipping records are arranged as ordered records, which are accessed by a record identifier. Each data set supports normal file services such as create file, open file, close file, delete file, read record, write record, and append record. Additionally, data sets have the ability to delete records, provide multiple views of records, create a new dataset based on an existing dataset, and some search criteria among other abilities. As discussed above, data server 28 may use the shipping records for billing purposes.

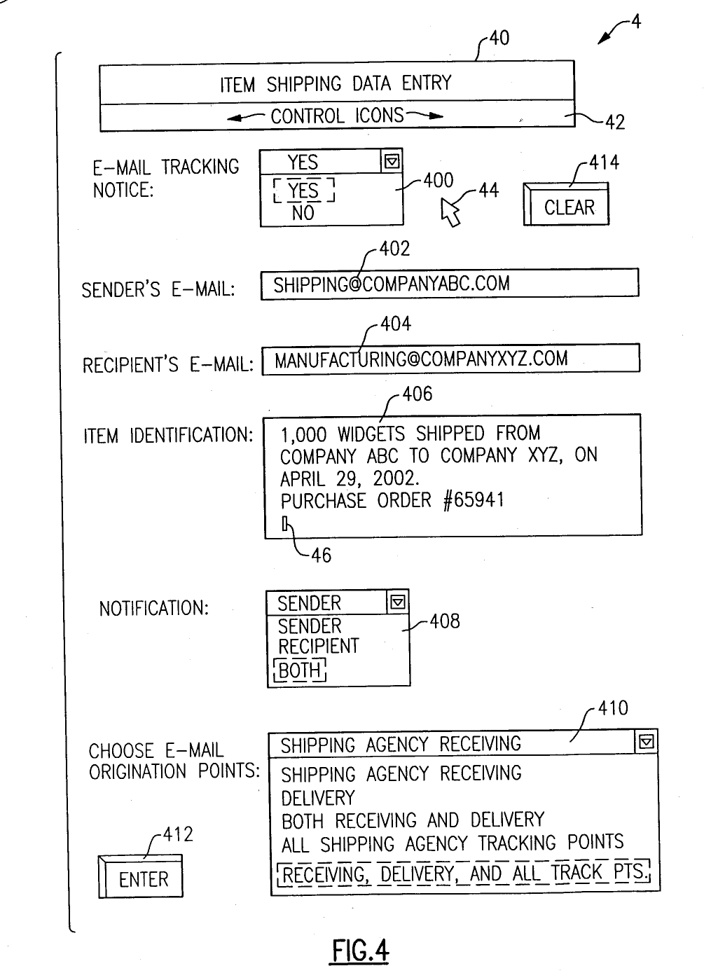

As embodied herein, and depicted in FIG. 4, a representation of a graphical user interface (GUI) provided by the system depicted in FIG. 2 is disclosed. Labeling system 120 is controlled primarily by software executed within microprocessor 200. As discussed above, microprocessor 200 is coupled to display 22, and receives user input from user input device 26. Input device 26 may be implemented using a keyboard, a mouse, a touch sensitive tablet or screen, a joystick, a track ball, or a screen activated light pen. As is well known to those skilled in the art, a GUI environment for a data processing system is implemented in software. The software program code is typically stored in ROM 206, but may be stored in any of the computer readable media described above. The program code may be distributed on such media, or may be distributed to users from the memory of one computer system over a network of some type to other computer systems, for use by users of such other systems. Such techniques and methods for embodying the software code on media and/or distributing the software code are well-known, and will not be further discussed herein.

Referring to FIG. 4, a pictorial representation of the graphic user interface environment is depicted. The environment employs graphic manipulation of selected graphic user interface elements in accordance with the method and system of the present invention. As depicted, a window is provided having a display area 4, which also may be utilized to display application or system related text, graphics, icons, image data, or the like not described below. Title bar 40 and control icon bar 42 are displayed along the top of the window. Control icon bar 42 provides a region for the display of window controls icons (not shown). Window title 40 may be utilized to designate an application name and/or an object name. In the example, title 40 designates the display as an “item shipping data entry” template. An “object” is an item that can be manipulated as a unit and that a user may work with to perform a task. An object may be represented as text, image, graphic, video, or audio. For example, a text file, which may comprise a document created by a word processing application, may be considered an object.

Control icon bar 42 may be utilized to control the display of the window. For example, a “maximize button” may be utilized to enlarge a window to the largest size possible for a particular view or to enlarge the size of the window to substantially fill the work place area of display screen 4. Similarly, a minimize button may be utilized to remove window 4 from the work place, and add a minimized-window visual, such as an application-defined icon, within the work place which represents the minimized window.

Pointer 44 is displayed on display screen 4, and is generally moved utilizing a pointing device, such as a mouse. Pointer 44 is utilized to designate choices and objects that a user may wish to select or otherwise interact with. As depicted in FIG. 4, pointer 44 is located adjacent to drop-down menu bar 400. The action lines depicted on drop-down menu bar 400 indicate the selection that pointer 44 has made using the mouse. Pointer 44 can also be used to position cursor 46 within the text entry areas, which are described below.

The GUI provides several types of data entry icons, including drop-down menu bars, text entry areas, and control buttons. As shown, GUI 4 includes at least three drop-down menu bars 400, 408, and 410. Those familiar with GUIs will appreciate that a command within drop-down menu bars may be selected graphically, utilizing a pointing device, such as a mouse, or by the selection of a particular keyboard key associated with a selected command. As shown, upon user selection of a particular command within the menu bar, a so-called “drop down” command list is provided and utilized to display individual commands which are categorized under the particular general command selected by the user from menu bar. Drop-down menu bar 400 is used by the user to indicate that the sender desires that a tracking status e-mail be sent. If the “yes” selection is made, the tracking status e-mail is authorized, and the sender will be billed for the service. If the “no” selection is made, tracking status e-mails will not be generated and the customer will not be charged for the service. In addition, if the “no” selection is made, the user will depress the “enter” control button 412 to end the session. Drop-down menu 408 is used to select the parties that are to be notified. As shown by the action lines, the user has indicated that both the sender and recipient should receive the tracking status e-mails. Drop down menu 410 is used to select the e-mail origination points. Again, as shown by the action lines, e-mails will be generated at the shipping/receiving facility, at the point of delivery, and at all tracking facility points therebetween.

Display area 4 includes at least three text entry areas 402, 404, and 406. Text entry area 402 is used to enter the sender's e-mail address. Text entry area 404 is used to enter the recipient's e-mail address. Those of ordinary skill in the art will recognize that areas 402 and 404 may be replaced by a larger single area that accommodates a plurality of e-mail addresses. It is contemplated that in some business environments, it may be desirable to have the status e-mail sent to more than two addresses. In this embodiment, notification command menu 408 is modified to accommodate all of the addresses. Text entry area 406 allows the user to enter an identification, or description, of the item being shipped.

Graphic display also 4 provides at least two control buttons 412 and 414. described above, button 412 is used to capture the information entered by the user. Button 414 allows the user to clear the screen 4, or to clear individual text areas, depending on the position and use of pointer 44.

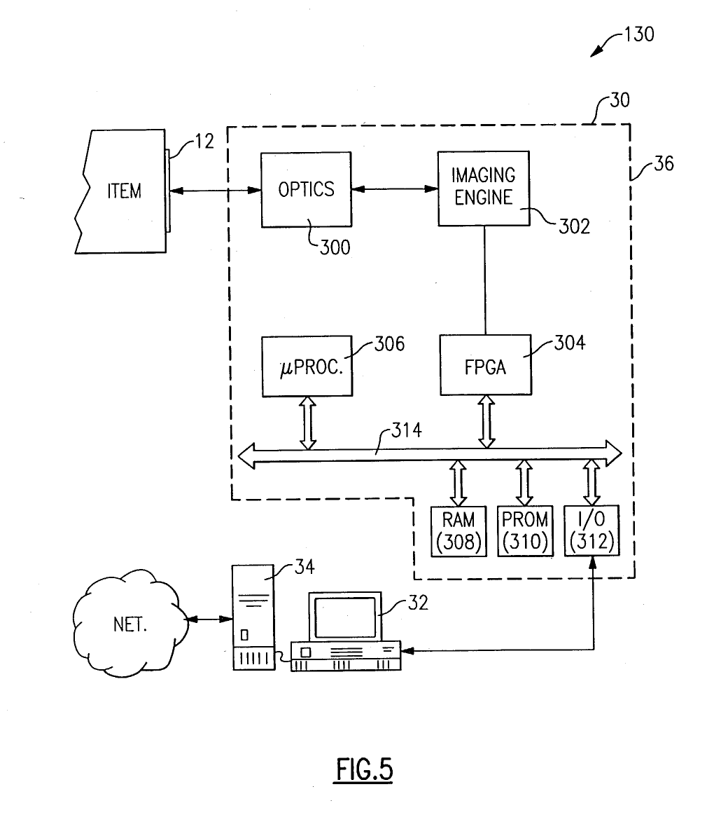

As embodied herein, and depicted in FIG. 5, a block diagram of the tracking facility 130 depicted in FIG. 1 is disclosed. Each tracking facility includes a reading device 30 coupled to computer 32. The facility may optionally include a data server. Thus, tracking facility computer 30 may be directly coupled to network 18, or coupled to network 18 via server 34. In one embodiment, computer 32 and server 34 may be of the type depicted in FIG. 2, and described in the associated text.

FIG. 5 shows an optical reader suitable for decoding two-dimensional bar codes. As described above, optical reader 30 is configured to read any suitable two-dimensional bar code. Optical reader 30 includes optics assembly 300 which is coupled to imaging engine 302. Imaging engine 302 is coupled to field programmable gate array (FPGA) 304. FPGA is coupled to system bus 314. Microprocessor 306, RAM 308, ROM 310, and I/O unit 312 are also coupled by way of system bus 314. The above described components are disposed in reader housing 36.

Reader housing 36 may be implemented as a portable scanner, or as a desk-top workstation or stationary scanner in which the bar code label is swiped across the reading head. In addition, reader housing 36 may be implemented as a scan “mouse”, in which the reading head is rolled over the two-dimensional bar code symbol. In another embodiment, the reader is implemented as a hand-held light-weight plastic housing, which is manually positioned by the user to contact bar code 12 affixed to the item.

Optics assembly 300 may be of any suitable type, but by way of example, optics assembly 300 includes an illumination optics assembly and an imaging optics assembly. The illumination optics includes a light source such as a light emitting diode (or an array of light emitting diodes) and a focusing lens (or an array of such lenses). The illuminations optics is configured to illuminate the field of view with a flood of light, typically in a narrow rectangular pattern. The reader is positioned over bar code symbol 12 so that at least an entire row of the symbol 12 is fully illuminated. The reflected or scattered light is returned to the reader through imaging optics. The imaging optics focuses the light onto imaging engine 302. If the imaging engine is a linear device, it can read only a single row at a time. Therefore, the reader 30 must be moved manually from the top of the symbol 12 to the bottom so that the entire symbol is scanned. However, the present invention is not limited to linear engines.

Imaging engine 302 may include a charge-coupled imaging device (CCD), a CMOS imaging device, or a charge modulation imaging device (CMD). The imaging device captures an image of two-dimensional bar code symbol 12, and converts the image of the bar code symbol to analog electrical signals. In one embodiment, the output of the imaging device is an analog signal in a standard RS-179 format representing the rows of the image being captured along with horizontal and vertical synchronization information.

Electrical signals from the imaging device are transmitted to a frame grabber circuit within imaging engine 302, which converts the signals into a digital representation of the original image. In one embodiment, the analog signals from the imaging device are converted to eight-bit gray-level values and transmitted to FPGA 304. FPGA 304 is tasked with controlling the image acquisition process, and the storage of image data. As part of the image acquisition process, FPGA 304 performs various timing and control functions including control of the light source and control of image engine 302. The digital representation of symbol 12 is decoded by microprocessor 306. Reader 30 may be configured to decode any suitable two-dimensional bar code symbol using methods well known in the art.

It will be apparent to those of ordinary skill in the pertinent art that modifications and variations can be made to microprocessor 306 of the present invention depending on cost, availability, and performance. In one embodiment, microprocessor 306 is implemented using an off-the-shelf VLSI integrated circuit (IC) microprocessor. Microprocessor 306 processes and decodes imaging data stored in RAM 308 in accordance with the programming instructions stored in ROM 310. The functionality of FPGA 304 may also be implemented using an application specific IC (ASIC). Those of ordinary skill in the art will also recognize that microprocessor 40 and programmable gate array 42 may be replaced by a single RISC processor.

As will be appreciated by those of ordinary skill in the pertinent art, modifications and variations can be made to the memory configuration of the present invention depending on cost and flexibility considerations. For example, ROM 310 may be implemented using EROMs, EPROMs or E²PROMs. FLASH memory may also be employed. RAM 308 typically includes at least one volatile memory device, and in some embodiments includes one or more long term non-volatile memory devices.

As described above, machine-readable identifier 12 may be implemented using an RF tag. In this embodiment, the bar code reader described above will be replaced by a RF reader or interrogator (not shown) suitable for use with the RF tag described above. The interrogator and the RF tag communicate by inductive coupling, as is well-known in the art. The interrogator includes a transmitter, a receiver, an antenna assembly, and data processing and control circuitry. The housing of the interrogator may be physically implemented as a portable RF scanner. Similarly, the bar code reader will be replaced by a magnetic card reader in the case where the identifier is a magnetic card.

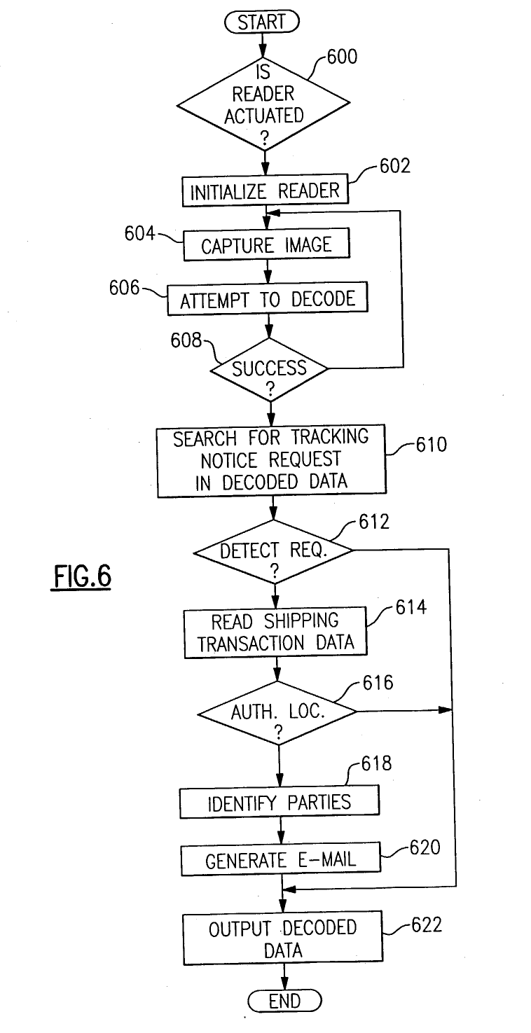

As embodied herein and depicted in FIG. 6, a method for operating the tracking facility 130 depicted in FIG. 5 is shown. The following discussion is provided with the two-dimensional bar code embodiment in mind. However, those of ordinary skill in the art will recognize that the method described herein is equally applicable to the RF tag and magnetic card embodiments described above. Upon pulling the trigger of the optical scanner, the reader is initialized using data stored in ROM 310. Soon thereafter, the image is captured and processor 306 attempts to decode the imaging data. If decoding is not successful, the image acquisition procedure is repeated. If the step of decoding is a success, the software searches for a tracking notice request. If it is present, the software is programmed to generate a tracking notice e-mail. Otherwise, the software merely displays the decoded data via the display on computer 32. Once the tracking notice request is detected in step 612, the software evaluates the shipping transaction data embedded in the bar code. In step 616, the software determines whether the tracking facility 130 is an authorized e-mail origination point. As discussed above, e-mail origination points are selected using the menu command bar 410 shown in FIG. 4. If so, the programming next determines the parties that are to be sent the tracking status e-mail. Again, the parties may include the item sender, the item recipient, both, or others. Finally, a tracking status e-mail is generated and transmitted to the parties. The e-mail may also be stored in a data structure on a computer readable medium as described above.

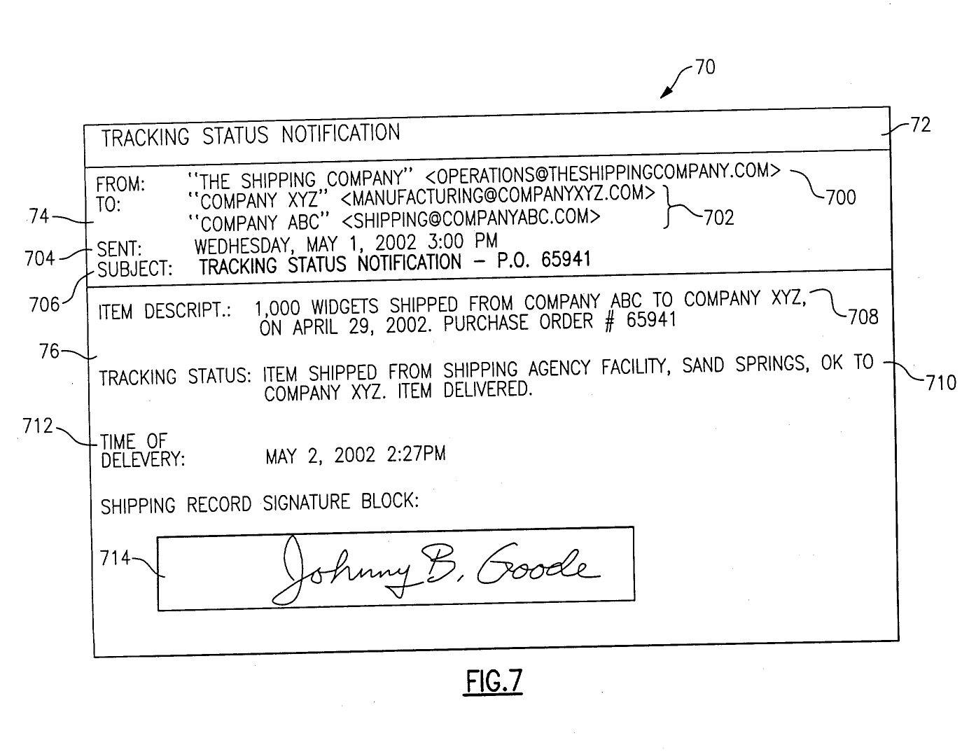

FIG. 7 is an example of an e-mail tracking status notification in accordance with an embodiment of the present invention. E-mail 70 follows the format of conventional e-mail messages. It includes a header 72 which displays the subject of the e-mail in bold type. Informational header 74 includes an identification field 700 which identifies the sender of the e-mail, in this case “the Shipping Company.” Header 74 includes a second identification field 702 to identify the recipient's of the e-mail. In this example, both the item sender (Company ABC) and the item recipient (Company XYZ), are sent the e-mail. Header 74 also includes field 704 and field 706. Field 704 provides the date and time the e-mail was sent, whereas subject matter field 706 identifies the subject matter of e-mail 70, which of course, is the tracking status of the item. In the example depicted in FIG. 7, the subject matter field 706 also includes the purchase order of the item. The body 76 portion of e-mail 70 includes at least four fields. The first field is the item description field 708. In this example, the item includes 1,000 Widgets shipped from Company ABC to Company XYZ, on Apr. 29, 2002. This field also identifies the purchase order as Purchase Order # 65941. The next field is tracking status field 710. As shown, the item was shipped from the Shipping Agency Facility in Sand Springs, Okla. and delivered to Company XYZ. In field 712, the reader of the e-mail is informed that the time of delivery was May 2, 2002, at 2:27PM. Finally, the e-mail includes Shipping Record Signature block 714 which shows the received signature bitmap from the delivery record. As shown, an individual named Johnny B. Goode signed for the 1,000 widgets at Company XYZ.

If in another scenario, the item was en route from the Shipping Agency Facility, the tracking status would indicate when the item left the facility, and the time of delivery would be an estimated time of delivery. In the second scenario, the signature field 714 would be blank for obvious reasons, e.g. the item is yet to be delivered.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A method for tracking an item being shipped from a sender to a recipient, the item traversing a shipping route that includes at least one tracking point facility, the method comprising:
affixing a machine-readable identifier on the item, the machine-readable identifier encoding data corresponding to the sender's e-mail address, the recipient's e-mail address, and an item description;
reading the machine-readable identifier at the at least one tracking point facility; and
automatically transmitting a tracking status e-mail in response to the step of reading, the e-mail being transmitted to at least one of the sender and the recipient, or both.

2. The method of claim 1, wherein the data includes an e-mail tracking notice request indicating that the sender requests that the tracking status e-mail be transmitted in response to the step of reading.

3. The method of claim 1, wherein the data includes notification data identifying the parties receiving the tracking status e-mail.

4. The method of claim 3, wherein the notification data specifies that only the sender receive the tracking status e-mail.

5. The method of claim 3, wherein the notification data specifies that only the recipient receive the tracking status e-mail.

6. The method of claim 3, wherein the notification data specifies that both the sender and recipient receive the tracking status e-mail.

7. The method of claim 1, wherein the machine-readable identifier comprises optical indicia.

8. The method of claim 1, wherein the machine-readable identifier comprises a bar code.

9. The method of claim 8, wherein the bar code is a two-dimensional bar code.

10. The method of claim 1, wherein the machine-readable identifier comprises a radio frequency tag.

11. The method of claim 1, wherein the machine-readable identifier comprises a magnetic card.

12. The method of claim 1, wherein the data includes a message density field identifying the at least one tracking point facility.

13. The method of claim 12, wherein the tracking status e-mail is only transmitted when the at least one tracking point facility is an item receiving point.

14. The method of claim 12, wherein the tracking status e-mail is only transmitted when the at least one tracking point facility is an item transfer point.

15. The method of claim 12, wherein the tracking status e-mail is only transmitted when the at least one tracking point facility is an item delivery point.

16. The method of claim 12, wherein the tracking status e-mail is transmitted at each tracking point facility.

17. The method of claim 1, wherein the item description includes purchase order information.

18. The method of claim 1, wherein the tracking status e-mail includes a date and time the tracking status e-mail was generated.

19. A system for tracking an item being shipped from a sender to a recipient, the system comprising:
a labeling device configured to affix a machine-readable identifier to the item, the machine-readable identifier being configured to encode data corresponding to an e-mail tracking notice request field, the sender's e-mail address, the recipient's e-mail address, and an item description; and
at least one tracking point facility configured to read the machine-readable identifier, generate a tracking status e-mail in response to detecting the e-mail tracking notice request field, and transmit the e-mail to at least one of the sender and the recipient.

20. The system of claim 19, wherein the system comprises a common carrier shipping system.

21. The system of claim 19, wherein the system comprises an intra-company system.

22. The system of claim 19, wherein the system comprises an inventory control system.

23. The system of claim 19, wherein the system comprises a component distribution system in a just-in-time manufacturing system.

24. The system of claim 19, wherein the labeling device is an optical indicia printer.

25. The system of claim 19, wherein the labeling device is a bar code printer.

26. The system of claim 25, wherein the bar code printer generates two-dimensional bar codes.

27. The system of claim 25, wherein the bar code printer further comprises:
a user interface;
a controller coupled to the user interface; and
a label printer coupled to the controller.

28. The system of claim 19, wherein the labeling device further comprises:
a display;
at least one input device; and
a processor coupled to the display and the at least one input device.

29. The system of claim 19, wherein the machine-readable identifier is an RF tag.

30. The system of claim 29, wherein the labeling device is a programming device configured to program the RF tag.

31. The system of claim 19, wherein the machine-readable identifier is a magnetic card device.

32. The system of claim 31, wherein the labeling device is a programming device configured to program the magnetic card device.

33. The system of claim 19, wherein the at least one tracking point facility is an item receiving point.

34. The system of claim 19, wherein the at least one tracking point facility is an item transfer point.

35. The system of claim 19, wherein the at least one tracking point facility is an item delivery point.

36. A computer readable medium having computer-executable instructions disposed thereon for performing a method for tracking an item being shipped from a sender to a recipient, the item traversing a shipping route that includes at least one tracking point facility, the method comprising:
reading sender shipping information including the sender's e-mail address, the recipient's e-mail address, and a description of the item;
disposing the sender shipping information in a machine-readable identifier; and
affixing the machine-readable identifier to the item, whereby the at least one tracking point facility automatically transmits a tracking status e-mail to one of the sender and recipient, or both, in response to the step of reading.

37. The method of claim 36, wherein the machine-readable identifier includes a tracking notice request, the at least one tracking point facility only generating the tracking status e-mail in response to detecting the tracking notice request.

38. The method of claim 36, wherein the step of reading further comprises:
providing at least one data entry form on a display;
inputting the sender shipping information into at least one data entry form using an input device, the information including the sender's e-mail address, the recipient's e-mail address, and a description of the item; and
encoding the sender shipping information in response to the step of inputting.

39. The method of claim 36, wherein the sender shipping data includes notification data identifying the parties receiving the tracking status e-mail.

40. The method of claim 36, wherein the notification data specifies that only the sender, or only the recipient, or both the sender and the recipient receive the tracking status e-mail.

41. The method of claim 36, wherein the step of disposing includes generating machine-readable optical indicia.

42. The method of claim 41, wherein the optical indicia is a bar code.

43. The method of claim 42, wherein the bar code is a two-dimensional bar code.

44. The method of claim 36, wherein the step of disposing includes programming an RF tag.

45. The method of claim 36, wherein the step of disposing includes programming a magnetic card.

46. A computer readable medium having computer-executable instructions disposed thereon for performing a method for tracking an item being shipped from a sender to a recipient, the item traversing a shipping route that includes at least one tracking point facility, the method comprising:
reading a machine-readable identifier affixed to the item, the machine-readable identifier encoding shipping transaction information, the shipping transaction information including a sender e-mail address field, a recipient e-mail address field, and an item identification field;
generating a tracking status e-mail in response to the step of reading; and
transmitting the tracking status e-mail to at least one of the sender and recipient, or both, in accordance with the shipping transaction information encoded in the optical indicia.

47. The method of claim 46, wherein the machine-readable identifier includes a tracking notice request, the at least one tracking point facility generating the tracking status e-mail only in response to detecting the tracking notice request.

48. The method of claim 46, wherein the step of reading includes scanning optical indicia.

49. The method of claim 46, wherein the step of reading includes scanning a bar code.

50. The method of claim 49, wherein the bar code is a two-dimensional bar code.

51. The method of claim 46, wherein the step of reading includes scanning an RF tag.

52. The method of claim 46, wherein the step of reading includes reading a magnetic card.

53. The method of claim 46, wherein the shipping transaction information includes notification data identifying the parties receiving the tracking status e-mail.

54. The method of claim 53, wherein the notification data specifies that only the sender, or only the recipient, or both the sender and the recipient receive the tracking status e-mail.

55. A machine-readable medium having stored thereon a data structure, the data structure comprising:
an e-mail tracking notice request field, the e-mail tracking notice request field including a command causing a reading device to generate a tracking status e-mail in response to detecting the e-mail tracking notice request field;
a sender e-mail address field;
a recipient e-mail address field; and
an item identification field including a description of the item being shipped.

56. The data structure of claim 55, further comprising a notification data field for identifying the parties receiving the tracking status e-mail.

57. The data structure of claim 56, wherein the notification data field specifies that only the sender, or only the recipient, or both the sender and the recipient receive the tracking status e-mail.

58. The data structure of claim 55, further comprising a notification message density field for identifying the at least one tracking point facility.

59. The data structure of claim 58, wherein the notification message density field specifies that the tracking status e-mail is only transmitted from an item receiving point.

60. The data structure of claim 58, wherein the notification message density field specifies that the tracking status e-mail is only transmitted from item transfer points.

61. The data structure of claim 58, wherein the notification message density field specifies that the tracking status e-mail is only transmitted from an item delivery point.

62. The data structure of claim 58, wherein the notification message density field specifies that the tracking status e-mail is transmitted from each tracking point facility, including an item receiving point, item transfer points, and an item delivery point.

63. The data structure of claim 55, wherein the item identification field includes a date and a time of the tracking status e-mail.

64. The data structure of claim 55, wherein the item identification field includes item purchase order information.

65. A computer readable medium having stored thereon a data structure corresponding to a tracking status e-mail, the tracking status e-mail being automatically generated in response to reading a machine-readable identifier, the machine-readable identifier being disposed on an item being shipped from a sender to a recipient, the data structure comprising:
a notification field identifying the sender and recipients of the e-mail;
a subject matter field of the tracking status e-mail;
an item identification field including a description of the item being shipped; and
and a tracking status field including a status of the item being shipped.

66. The data structure of claim 65, wherein the tracking notification field is configured to be compatible with automated e-mail field scraping software that automatically queries the subject matter field of an e-mail for the presence of the notification field.

67. The data structure of claim 65, further comprising a signature field, the signature field including a signature bit-map of an item shipping record.

68. The data structure of claim 65, wherein the tracking status field includes the location of the item at the time the tracking status e-mail is generated.

69. The data structure of claim 65, wherein the tracking status field includes the time and date of the tracking status e-mail.

70. The data structure of claim 65, wherein the tracking status field includes an estimated time of delivery of the item.

71. A reading apparatus for reading a machine-readable identifier disposed on an item being shipped from a sender to a recipient, the reading apparatus comprising:
a reader assembly configured to acquire data disposed in the machine-readable identifier; and
a processor coupled to the reader assembly, the processor being programmed to,
detect an e-mail tracking notice request embedded in the machine-readable identifier,
decode a sender's e-mail address, a recipient's e-mail address, and an item description embedded in the machine-readable identifier, and
transmit a tracking status e-mail to at least one of the sender and the recipient, or both, in response to detecting the e-mail tracking notice request.

72. The reading apparatus of claim 71, wherein the reader assembly is configured to read optical indicia.

73. The reading apparatus of claim 71, wherein the reader assembly includes an imaging assembly configured to scan a bar code and generate image data corresponding to the bar code.

74. The reading apparatus of claim 73, wherein the processor is configured to decode the image data in the process of detecting the e-mail tracking notice request and decoding a sender's e-mail address, a recipient's e-mail address, and an item description embedded in the identifier.

75. The reading apparatus of claim 73, wherein the bar code is a two-dimensional bar code.

76. The reading apparatus of claim 71, wherein the reader assembly includes an scanning assembly configured to scan an RF tag.

77. The reading apparatus of claim 71, wherein the reader assembly includes an reading assembly configured to read a magnetic card.

78. The reading apparatus of claim 71, further comprising:
a display device coupled to the processor; and
at least one user input device coupled to the processor.

79. The reading apparatus of claim 71, wherein the tracking status e-mail comprises:
a notification field corresponding to a subject matter field of the tracking status e-mail;
an item identification field including a description of the item being shipped;
a signature field, the signature field including a signature bit-map of an item shipping record; and
a tracking status field including a status of the item being shipped.

80. A system for producing a machine-readable identifier for use in tracking an item being shipped from a sender to a recipient, the system comprising:
a user interface configured to input sender shipping information, the sender shipping information including an e-mail tracking notice request, the sender's e-mail address, the recipient's e-mail address, and an item description;
a controller coupled to the user interface, the controller being configured to embed the sender shipping information in a machine-readable identifier; and
an affixing device coupled to the controller, the affixing device being configured to affix the machine-readable indicia to the item.

81. The system of claim 80, wherein the machine-readable identifier includes optical indicia.

82. The system of claim 80, wherein the machine-readable identifier is a bar code and the affixing device comprises a bar code printer.

83. The system of claim 82, wherein the bar code printer generates two-dimensional bar codes.

84. The system of claim 80, wherein the machine-readable identifier is an RF tag, and the affixing device comprises a programming device configured to program the RF tag.

85. The system of claim 80, wherein the machine-readable identifier is a magnetic card device, and the affixing device comprises a programming device configured to program the magnetic card device.

86. In a computer system having a graphical user interface including a display and at least one input device, a method for providing information used for tracking an item being shipped from a sender to a recipient, the method comprising:
providing at least one data entry icon on the display;
inputting the information into the at least one data entry form using the input device, the information including the sender's e-mail address, the recipient's e-mail address, and a description of the item;
encoding the information in response to the step of inputting, whereby the information is encoded in a machine-readable identifier; and
affixing the machine-readable identifier to the item.

87. The method of claim 86, wherein the machine-readable identifier includes optical indicia.

88. The method of claim 86, wherein the machine-readable identifier is a bar code.

89. The method of claim 88, wherein the bar code is a two-dimensional bar code.

90. The method of claim 86, wherein the machine-readable identifier comprises an RF tag device.

91. The method of claim 86, wherein the machine-readable identifier comprises a magnetic card device.
